(19) United States
(12) Patent Application Publication
(10) Pub. No.: US 2024/0359518 A1
(43) Pub. Date: Oct. 31, 2024

(54) AUTOMOTIVE SUSPENSION ASSEMBLIES

(71) Applicant: REE AUTOMOTIVE LTD., Glil-Yam (IL)

(72) Inventor: Eran STARIK, Tel Aviv (IL)

(21) Appl. No.: 18/563,607

(22) PCT Filed: Jun. 2, 2022
(86) PCT No.: PCT/IB2022/055164

§ 371 Date: Nov. 22, 2023

Related U.S. Application Data
(60) Provisional application No. 63/196,467, filed on Jun. 3, 2021.

(51) Int. Cl. B60G 17/015; B60G 13/10; B60K 25/10

(52) U.S. Cl. CPC B60G 17/0157; B60G 13/10; B60K 25/10; B60G 2202/242; B60G 2202/25; B60G 2204/16; B60G 2300/60; B60G 2400/0516; B60G 2500/10

(57) ABSTRACT

A suspension assembly includes a shock absorber arranged to damp linear motion of a piston portion relative to a surrounding cylinder portion. A lead screw is disposed within the shock absorber for conversion between linear kinetic energy and rotational kinetic energy. The suspension assembly also includes an electric motor displaced externally from the shock absorber, for conversion between rotational kinetic energy and electricity, and a transmission arrangement disposed outside the shock absorber, mediating between the shock absorber and the motor, and configured to transfer a resistance torque from the motor to the lead screw so as to modulate the damping of the linear motion.

### CROSS-REFERENCE TO RELATED APPLICATIONS

This patent application claims the benefit of U.S. Provisional Patent Application No. 63/196,467, filed on Jun. 3, 2021, which is incorporated herein by reference in its entirety.

### FIELD OF THE INVENTION

The present invention relates to active suspension assemblies for vehicles, and particularly to suspension assemblies with controllable shock-absorber damping and recuperation of kinetic energy.

### BACKGROUND

Automotive suspension systems have been developed and improved over the course of more than a century, resulting in sophisticated designs for controlling the characteristics of shock absorbers and capturing a portion of the kinetic energy previously dissipated as heat.

Newly-conceived vehicle platforms designed for electric propulsion can include modular axle-less wheel assemblies (“vehicle corner modules”, or VCMs) requiring intelligent and efficient suspension systems, which require new mechanical and electronic solutions.

### SUMMARY

According to embodiments disclosed herein, an energy-regenerative suspension assembly comprises (a) a pneumatic shock absorber arranged to restrain linear motion of a piston portion relative to a surrounding cylinder portion, a lead screw being disposed within the shock absorber to translate a linear-kinetic-energy portion of the linear motion to rotational kinetic energy; (b) an electric motor displaced externally from the shock absorber, the motor being operative to convert rotational kinetic energy of a rotor portion thereof to electricity; and (c) a transmission arrangement disposed outside the shock absorber, mediating between the shock absorber and the motor, and configured to receive a bidirectional torque from the lead screw and to transfer a unidirectional torque to the rotor portion to generate electricity. In some embodiments, the transmission arrangement can mediate between the lead screw and the rotor portion of the motor. In some embodiments, the transmission arrangement can be configured (or additionally configured) to transfer a resistance torque from the motor to the lead screw so as to modulate the restraining of the linear motion.

In some embodiments, the motor can be operative to effect a change in mechanical resistance of the lead screw in response to an instruction from a control system. In some such embodiments, the control system can include a rotation sensor for determining a rotation parameter of a rotating component of the transmission arrangement, and one or more computer processors for using the rotation parameter to generate the instruction. In some such embodiments, the control system can include a rotation sensor for determining a rotation parameter of the lead screw, and one or more computer processors for using the rotation parameter to generate the instruction. The suspension assembly of any preceding claim, wherein the lead screw is rotatably coupled to the cylinder portion, and an opposing lead-screw nut is fixedly coupled to the piston portion.

In some embodiments, the transmission arrangement can comprises: (i) a lead shaft conjoined to the lead screw to receive therefrom a bi-directional rotational motion, (ii) an intermediate shaft in rotational drive communication with the lead shaft for bidirectional rotation in respective opposing directions thereto, the intermediate shaft being in rotational drive communication with the rotor portion of the motor, the rotor portion comprising a motor shaft, and/or (iii) first and second unidirectional rotation-modulators respectively coupled with two shafts selected from the group of shafts containing the lead shaft, the motor shaft, and the intermediate shaft, so as to transfer a unidirectional torque to the motor shaft.

In some embodiments, the transmission arrangement can comprise: (i) a first gear conjoined coaxially to the lead screw for bidirectional rotation together therewith, (ii) a second gear conjoined coaxially to an intermediate shaft and in geared communication with the first gear for bidirectional rotation in respective opposing directions thereto, and/or (iii) respective first and second unidirectional bearings engaging the lead screw and the intermediate shaft with the rotor portion so as to transfer thereto a unidirectional torque. In some embodiments, the first and second unidirectional bearings can be engaged with the rotor portion by respective belt drives. In some embodiments, respective central axes of the lead screw and of the rotor portion of the electric motor can be aligned in parallel with each other and laterally displaced from each other.

In some embodiments, (i) a wheel assembly can comprise the energy-regenerative suspension assembly of any the embodiments disclosed above; and (ii) either the piston portion of the shock absorber or the cylinder portion of the shock absorber can be coupled to an unsprung portion of the wheel assembly, and/or the transmission arrangement can be coupled to a sprung portion of the wheel assembly. In some such embodiments, the wheel assembly can additionally comprise an energy storage device for storing electricity generated by the motor. In some such embodiments, a vehicle can comprise the wheel assembly, the sprung portion is mechanically joined to a reference frame of the vehicle.

In some embodiments, a vehicle can comprise the suspension assembly of any of the embodiments disclosed above, and the shock absorber can be disposed between a reference frame of the vehicle and a wheel assembly.

According to embodiments disclosed herein, an energy-regenerative suspension assembly comprises: (a) a pneumatic shock absorber arranged to damp linear motion of a piston portion relative to a surrounding cylinder portion, a lead screw being disposed within the shock absorber for conversion between linear kinetic energy and rotational kinetic energy; (b) an electric motor displaced externally from the shock absorber, for conversion between rotational kinetic energy and electricity; and (c) a transmission arrangement disposed outside the shock absorber, mediating between the shock absorber and the motor, and configured to transfer a resistance torque from the motor to the lead screw so as to modulate the damping of the linear motion. In some embodiments, the transmission arrangement can mediate between the lead screw and a rotor portion of the motor. In some embodiments, the transmission arrangement can be configured to receive a bidirectional torque from the lead screw and to transfer a unidirectional torque to a rotor portion of the motor to generate electricity.

In some embodiments, the motor can be operative to effect a change in mechanical resistance of the lead screw in response to an instruction from a control system. In some such embodiments, the control system can include a rotation sensor for determining a rotation parameter of a rotating component of the transmission arrangement, and one or more computer processors for using the rotation parameter to generate the instruction. In some such embodiments, the control system can include a rotation sensor for determining a rotation parameter of the lead screw, and one or more computer processors for using the rotation parameter to generate the instruction. In some embodiments, the lead screw can be rotatably coupled to the cylinder portion, and/or an opposing lead-screw nut can be fixedly coupled to the piston portion. In some embodiments, respective central axes of the lead screw and of the rotor portion of the motor can be aligned with each other and laterally displaced from each other. In some such embodiments, the aligning can be a parallel aligning.

In some embodiments, (i) a wheel assembly can comprise the energy-regenerative suspension assembly disclosed in any of the above embodiments; and (ii) either the piston portion of the shock absorber or the cylinder portion of the shock absorber can be coupled to an unsprung portion of the wheel assembly, and the transmission arrangement can be coupled to a sprung portion of the wheel assembly. In some such embodiments, the sprung portion can be mechanically joined to a reference frame of a vehicle, or configured to be mechanically joined to a reference frame of a vehicle. In some embodiments, the shock absorber can be is disposed between a reference frame of a vehicle and a wheel assembly, or configured to be disposed between a reference frame of a vehicle and a wheel assembly.

According to embodiments disclosed herein, a vehicle suspension assembly comprises a pneumatic shock absorber, an electric motor displaced externally therefrom, and an external transmission arrangement mediating between the shock absorber and the motor. In an operating state: (i) bidirectional linear motion of one or more shock-absorber portions is effective to bidirectionally rotate a lead screw disposed within the shock absorber and, via the transmission arrangement, unidirectionally rotate a rotor portion of the motor to generate electricity, and (ii) the transmission arrangement is effective to transfer a modulated resistance torque of the motor to the lead screw to regulate the linear motion, the resistance torque of the motor being modulated in response to an instruction from a control system. In some embodiments, the control system can include a rotation sensor for determining a rotation parameter of a rotating component of the transmission arrangement, and one or more computer processors for using the rotation parameter to generate the instruction. In some embodiments, the control system can include a rotation sensor for determining a rotation parameter of the lead screw, and one or more computer processors for using the rotation parameter to generate the instruction. In some embodiments, the transmission arrangement can mediate between the lead screw and the rotor portion of the motor. In some embodiments, the lead screw can be rotatably coupled to the cylinder portion, and/or an opposing lead-screw nut can be fixedly coupled to the piston portion.

In some embodiments, the transmission arrangement can comprise: (i) a first gear conjoined coaxially to the lead screw for bidirectional rotation together therewith, (ii) a second gear conjoined coaxially to an intermediate shaft and in geared communication with the first gear for bidirectional rotation in respective opposing directions thereto, and/or (iii) respective first and second unidirectional rotation-modulators engaging the first and second gears with the rotor portion so as to transfer thereto a unidirectional torque. In some embodiments, respective central axes of the lead screw and of the rotor portion of the electric motor can be aligned in parallel with each other and laterally displaced from each other.

In some embodiments, (i) a wheel assembly can comprise the energy-regenerative suspension disclosed in any of the above embodiments, and (ii) either the piston portion of the shock absorber or the cylinder portion of the shock absorber can be coupled to an unsprung portion of the wheel assembly, and the transmission arrangement can be coupled to a sprung portion of the wheel assembly. In some such embodiments, the sprung portion can be is mechanically joined to a reference frame of a vehicle. In some embodiments, the wheel assembly can comprise an energy storage device for storing electricity generated by the motor. In some embodiments, the shock absorber can be disposed between a reference frame of a vehicle and a wheel assembly.

According to embodiments disclosed herein, a wheel assembly for regulating motion of a host vehicle comprises: (a) a suspension subsystem comprising an energy-regenerative suspension assembly that includes a pneumatic shock absorber and a motor, the energy-regenerative suspension assembly being configured to convert linear motion of one or more shock-absorber portions to electricity and to regulate the linear motion by modulating a resistance torque of the motor; (b) an energy storage device for storing electricity generated by the energy-regenerative suspension assembly; and (c) an electronics array for controlling the operation of the suspension subsystem and of at least one other subsystem of the wheel assembly, the at least one other subsystem selected from the group of subsystems consisting of a drive subsystem, a steering subsystem, and a braking subsystem. The electronics array is powered by the energy storage device.

In some embodiments, the shock absorber can include a lead screw disposed within the shock absorber to translate a linear-kinetic-energy portion of the linear motion to rotational kinetic energy. In some embodiments, the energy-regenerative suspension assembly can additionally include a transmission arrangement disposed outside the shock absorber, mediating between the shock absorber and the motor, and configured to receive a bidirectional torque from the lead screw and to transfer a unidirectional torque to the rotor portion to generate electricity. In some embodiments, the transmission arrangement can be configured to transfer a resistance torque from the motor to the lead screw to modulate the restraining of the linear motion. In some embodiments, a shock-absorber portion can be coupled to an unsprung portion of the wheel assembly, and/or the transmission arrangement can be coupled to a sprung portion of the wheel assembly. In some such embodiments, the sprung portion can be mechanically joined to a reference frame of a vehicle, or configured to be mechanically joined to a reference frame of a vehicle. In some embodiments, the electronics array can include at least one electronic device selected from the group of electronic devices containing controllers and sensors.

In some embodiments in which the shock absorber includes a lead screw, the modulating of the resistance torque of the motor can be responsive to, e.g., in response to and/or contingent upon, receiving an instruction from a control system that includes (i) a rotation sensor for determining a rotation parameter of the lead screw, and (ii) one or more computer processors for using the rotation parameter to generate the instruction.

In some embodiments in which the energy-regenerative suspension assembly includes a transmission arrangement, the modulating of the resistance torque of the motor can be in response to an instruction from a control system that includes a rotation sensor for determining a rotation parameter of a rotating component of the transmission arrangement, and one or more computer processors for using the rotation parameter to generate the instruction. The rotating component can be, for example, an intermediate shaft of the transmission arrangement or a gear or bearing that rotates together therewith.

According to embodiments disclosed herein, a wheel assembly for a vehicle comprises: (a) an energy-regenerative suspension assembly comprising: (i) a pneumatic shock absorber comprising two portions slidably engaged with each other, linear motion of one or more of the portions being effective to rotate a lead screw disposed within the shock absorber, and (ii) an electric motor displaced externally from the shock absorber and in geared communication therewith, for generating electricity from the linear motion and for generating a resistance torque to the lead screw to regulate the linear motion. The wheel assembly additionally comprises: (b) a control system including a rotation sensor for determining a rotation parameter of the suspension assembly, and one or more computer processors for using the rotation parameter to cause a modulation of the resistance torque.

In some embodiments, the suspension assembly can additionally comprise a transmission arrangement mediating between the lead screw and a rotor portion of the motor, the transmission arrangement being configured to transfer a torque from the lead screw to the rotor portion for generating the electricity, and to transfer the resistance torque from the motor to the lead screw for regulating the linear motion.

In some embodiments, the rotation parameter includes a rotation parameter of the lead screw. In some embodiments, the rotation parameter includes a rotation parameter of a rotating component of the transmission arrangement, for example, an intermediate shaft of the transmission arrangement or a gear or bearing that rotates together therewith.

In some embodiments, the wheel assembly can additionally comprise an energy storage device for storing electricity generated by the motor.

In some embodiments, the control system can additionally include at least one sensor selected from: a sensor for sensing vehicle roll, and a sensor for sensing a lateral force acting upon the wheel assembly or a component thereof, the one or more processors being configured to use a measurement of the additionally-included at least one sensor to cause the modulation of the resistance torque.

A method is disclosed, according to embodiments, of regulating a damping force in a vehicle suspension assembly. According to the method, the suspension assembly comprises (i) a pneumatic shock absorber, (ii) an electric motor displaced externally from the shock absorber, and (iii) an external transmission arrangement mediating between the shock absorber and the motor. The method comprises: (a) monitoring rotation of a suspension-assembly component; (b) determining, from the monitored rotation, an absorption profile of the shock absorber; and responsively to an actuation signal received from a control system, regulating a resistance torque in the motor to apply a resistance profile. According to the method, the transmission arrangement is arranged to transfer the regulated resistance torque to the shock absorber to regulate a damping force therein. In some embodiments, the regulating of the damping force can be effective to regulate a linear motion of a piston portion of the shock absorber relative to a cylinder portion of the shock absorber. In some embodiments, a lead screw can be disposed within the shock absorber to translate between linear motion and rotational motion. In some embodiments, respective central axes of the lead screw and of a rotor portion of the motor can be aligned in parallel with each other and laterally displaced from each other.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1A is a schematic illustration of an energy-regenerative suspension assembly according to embodiments of the invention;

FIG. 1B is a schematic illustration of the energy-regenerative suspension assembly of FIG. 1A, indicating the motion of various components in a mode of operation, according to embodiments of the present invention;

FIGS. 2A and 2B are schematic representations of an energy-regenerative suspension assembly showing aspects of controlling a shock absorber characteristic, according to embodiments of the present invention;

FIG. 3 is a block diagram of a power and communication scheme, according to embodiments of the present invention;

FIGS. 4-8 are flowcharts showing steps of methods for controlling a shock absorber of an energy-regenerative suspension assembly, according to embodiments of the present invention.

FIG. 9 is a schematic illustration of a communication scheme between parties associated with a vehicle equipped with a vehicle corner module (VCM), according to embodiments of the invention;

FIG. 10 is a schematic drawing of a vehicle comprising a plurality of VCMs, according to embodiments of the present invention;

FIG. 11 is a schematic illustrations of a VCM comprising a plurality of sub-systems, according to embodiments of the present invention;

FIG. 12 is a partial schematic representation of a vehicle suspension system incorporating an energy-regenerative suspension assembly according to embodiments of the present invention;

FIG. 13 is a schematic illustration of control and communication between a vehicle platform and one or more VCMs, according to embodiments of the present invention;

FIG. 14 is a schematic diagram of a VCM-controller, according to embodiments of the present invention;

FIG. 15 is a schematic diagram of a suspension-system controller, according to embodiments of the present invention; and

FIG. 16 illustrates selected electrical and/or electronic connections of a suspension-system motor and other vehicle components, according to embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous elements.

### DETAILED DESCRIPTION OF THE PRESENT INVENTION

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Note: Throughout this disclosure, subscripted reference numbers (e.g., 101 or 10A) may be used to designate multiple separate appearances of elements of a single species, whether in a drawing or not; for example: 101 is a single appearance (out of a plurality of appearances) of element 10. The same elements can alternatively be referred to without subscript (e.g., 10 and not 101) when not referring to a specific one of the multiple separate appearances, i.e., to the species in general.

According to embodiments, a shock absorber is provided as a component of a suspension-system sub-assembly that is part of an ‘active suspension system’, i.e., a suspension system with controllable damping/restraining of shocks absorbed by the shock absorber.

The shock absorber disclosed herein has disposed therewithin a mechanism for converting linear motion to rotational motion. As an example, the shock absorber is built of a cylinder and a piston, and a lead screw can be engaged with whichever one of the cylinder and the piston is in the vehicle-connected or vehicle-proximate end of the shock absorber, and a corresponding lead-screw nut can be engaged with whichever one of the cylinder and the piston is in the wheel-connected or wheel-proximate end. The relative linear motion (i.e., of the piston relative to the cylinder or vice versa) causes the lead-screw nut to move ‘up and down’. (The phrase ‘up and down’ is meant to indicate longitudinal motion co-axial with a longitudinal axis of the shock absorber, even if not strictly ‘up and down’.) The linear up-and-down movement of the lead-screw nut forces the lead screw to rotate about its longitudinal axis. The linear motion of the piston/cylinder is thus converted to rotational motion of the lead screw; similarly, the linear force of the sliding portion of the shock absorber (the piston or cylinder according to specific design) is transferred to a rotation force (torque), and the linear kinetic energy of the sliding portion is converted to rotational kinetic energy.

The suspension-system sub-assembly comprising the shock absorber also comprises, according to embodiments, an electric motor and a gearing arrangement (or, more broadly but equivalently, a transmission arrangement) mediating between the shock absorber and the motor, or equivalently, between the lead screw and a rotor portion of the motor. When the suspension assembly is installed in a vehicle, the shock absorber is coupled between a sprung and an unsprung portion of a wheel assembly. The shock is thus placed to restrain, or damp, the motion of the unsprung mass of the wheel assembly towards (and away from) the sprung mass of the vehicle.

The gearing arrangement is arranged to convert the bidirectional motion of the piston/cylinder and lead screw to unidirectional rotation of the motor rotor, i.e., rotation that is limited to a single direction of rotation. A unidirectional arrangement has a potential of increasing efficiency of the energy recuperation and of the kinetic energy transmission (e.g. reducing loses due to electro magnetic and/or friction forces and/or, inertia moments, etc). According to embodiments, system efficiency and reliability, and component durability, are further enhanced by displacing the transmission arrangement externally and laterally from the shock absorber to provide an intermediate (direction-changing) shaft that is substantially parallel to the lead screw shaft, and a motor shaft that is substantially parallel to the other two shafts.

According to some embodiments, the rotation of the lead screw is translated to rotation of the rotor portion of the motor to generate electricity. Thus, the suspension assembly can be effective to recuperate, or, equivalently, regenerate, energy from the kinetic energy in the shock absorber. The recuperated energy can be stored in a rechargeable power source such as a battery or capacitor (e.g., supercapacitor or ultracapacitor) and used to power various components of the wheel assembly or the vehicle.

According to some embodiments, control arrangements are provided for controlling the rotation of the motor rotor to increase or decrease resistance torque in order to change the motion profile of the shock absorber to be stiffer or less stiff. In some embodiments, additional mechanical arrangements, such as a control gear engaged with the motor rotor, can be provided to assist in implementing the control instructions. The controlling can be in response to road conditions, load, speed and/or other factors which can affect the vehicle ride and create a need to regulate the damping of the shock absorber. The controlling can employ a variety of sensors, including sensors monitoring movement, e.g., rotation, of elements within the transmission arrangement, linear motion of the shock absorber, and/or sensors monitoring external parameters such as road conditions. The controlling can be effective to shorten or extend the linear motion of the piston/cylinder, and/or to increase or decrease the amount of linear force is required to produce a given amount of linear motion, in order to increase or reduce stiffness, respectively.

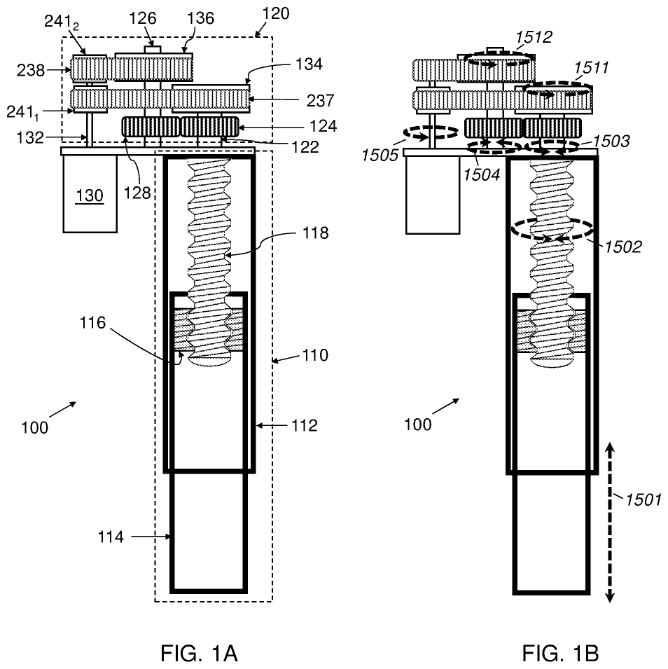

A non-limiting example of an active suspension assembly 100 according to embodiments is illustrated schematically in FIGS. 1A and 1B. FIG. 1A is a structural view of the assembly for identifying the individual components, while FIG. 1B can be used for understanding at least part of the functionality of the assembly in terms of movement and rotation in an operating mode. Some components may have been omitted for the sake of simplicity, and not all components need be present in an assembly 100 provided in accordance with embodiments of the invention. Additionally, gear ratios may be adjusted in various implementations and the schematically-illustrated sizes and designs of the various components should not be understood as being limited in any way to the specific designs shown. In the example of FIGS. 1A and 1B, a shock absorber 110 comprises a cylinder 112 and a piston 114, the piston 114 disposed partly within the cylinder 112 and free to slide up and down therein in a bidirectional linear motion indicated by arrow 1501 in FIG. 1B. In other examples, not shown, the piston can be above the cylinder and not as illustrated, and such examples are within the scope of the invention. The piston 114 has affixed thereto a lead-screw nut 116 corresponding to a lead screw 118 that is disposed within the cylinder 112. The linear motion 1501 is translated to rotational motion of the lead-screw 118 as indicated by the arrow 1502 in FIG. 1B.

The suspension assembly 100 further comprises transmission arrangement 120 and a motor 130 disposed outside the cylinder 112 and displaced laterally therefrom.

It can be desirable for electric motor 130 provided in geared engagement with the shock absorber 110 via the transmission arrangement 120 to be limited to unidirectional rotation, e.g., to achieve higher efficiency of energy recuperation by avoiding inertial losses from changing the rotation direction of the motor. Further, in some motor designs, a rotor can be designed to convert electricity to rotational kinetic energy when rotated in a first direction, and to generate electricity from rotational kinetic energy when rotated in the second direction. In some designs, the rotor portion of the motor includes the motor shaft, and in other designs the shaft is configured as a stator with a surrounding cylinder configured as a rotor.

As shown in FIGS. 1A and 1B, transmission arrangement 120 is rotatably engaged with the lead screw 118 and the motor 130 to convert bidirectional rotation 1502 of the lead screw 118 to a unidirectional rotation 1505 of the motor rotor 132. The transmission arrangement 120 comprises a lead-screw shaft 122, an intermediate shaft 226, and motor shaft 132.

As can be understood from arrows 1501, 1502, 1503, 1504, and 1505 in FIG. 1B, bidirectional linear motion 1501 of piston 114 relative to the cylinder 112 is translated into to a unidirectional rotation 1505 of the motor rotor 132 via bidirectional rotational motion 1502, 1503, and 1504, respectively of the lead-screw 118, the lead screw shaft 122, and the intermediate-shaft 126.

The exemplary design of FIGS. 1A and 1B includes a set of unidirectional bearings or clutches (or, more broadly, unidirectional rotation-modulators, which can include any mechanisms for transferring rotational motion in only one direction) to convert the aforementioned bidirectional rotation to a unidirectional rotation of the motor rotor 132.

According to some embodiments, lead-screw shaft 122 is coupled to lead screw 118. In some embodiments, lead-screw shaft 122 is coaxially conjoined with, e.g., fixedly attached to, the lead-screw 118. The rotation 1502 of the lead screw 118 causes the lead-screw shaft 122 to rotate, as indicated by the arrow 1503 in FIG. 1B.

According to some embodiments, the respective longitudinal central axes of the lead screw 118 and of a rotor portion of the motor 130 (e.g., the motor shaft 132) are aligned to be substantially parallel with each other and laterally displaced from each other. In some embodiments, the lead screw shaft 122, intermediate shaft 126, and motor shaft 132 are aligned in parallel with each other and laterally displaced from each other.

In some embodiments, a lead-screw gear 124 is coaxially conjoined with, e.g., fixedly attached to, the lead-screw shaft 122. An intermediate-shaft gear 128 is coaxially conjoined with the intermediate shaft 126, and is engaged with the lead-screw gear 124, e.g., the two gears are meshed with each other, so that the intermediate-shaft gear 128 rotates in the opposite direction of the lead-screw gear 124, as indicated by arrow 1504 in FIG. 1B-in other words, if the lead screw 118 and the lead-screw gear 124 rotate clockwise, then the intermediate-shaft gear 128 rotates counter-clockwise, and vice-versa.

As illustrated, each of the lead-screw shaft 122 and the intermediate shaft 126 is engaged with a respective one-way bearing 134, 13 which transmits rotational motion in a single direction, as indicated in FIG. 1B by arrows 1511, 1512, respectively. Counter-clockwise rotation of the one-way bearings 134, 136 is shown only for illustration, and in other examples the rotation is clockwise, all depending on how the motor 130 or transmission arrangement 120 are arranged. The unidirectional rotation 1511 or 1512 (i.e., both 1511 and 1512, but alternatingly) is transferred to the rotor portion of the motor 130, as indicated by arrow 1505 in FIG. 1B. In the instant example, the rotor portion comprises the motor shaft 132. Thus, the bidirectional linear motion 1501 of the piston 114 relative to the cylinder 112 is converted to unidirectional rotational motion 1505 of the shaft 132 (rotor portion) of the motor 130.

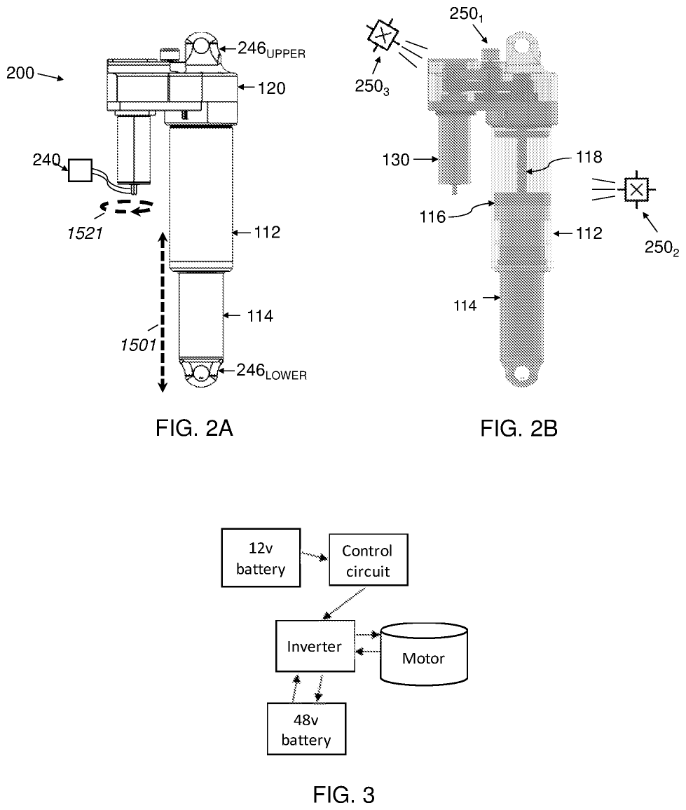

We now refer to FIGS. 2A and 2B, which show two schematic drawings of a suspension assembly 100 according to embodiments. The suspension assembly 200 is similar to suspension assembly 100 (e.g. having a motor 130, shock absorber cylinder 112, piston 114, lead screw 118 and transmission arrangement 120) is shown to include two end-covering components 246_{UPPER} and 246_{LOWER}. Each of the two components 246_{UPPER} and 246_{LOWER} are shown as unibody components but can alternatively be constructed from multiple elements. The components 246_{UPPER} and 246_{LOWER} not only protect other elements of the assembly from damage and exposure to water and dirt, etc., but also provide connection points for installing the suspension assembly 200.

In embodiments, the suspension-system motor 130 is effective to provide a variable resistance torque, i.e., to regulate a resistance torque, indicated by the arrow 1521 in FIG. 2A. The resistance torque 1521 is transferred by the transmission arrangement 120 to the lead screw 118 in order to modulate the damping of the linear motion 1501 of the piston 114 relative to the cylinder 112. The resistance torque 1521 can be regulated in response to an instruction from a control system, e.g., suspension-system controller 240, or by another controller aboard a wheel assembly, a vehicle corner module, or a vehicle. The regulating can include increasing the resistance torque 1521 in order to make the suspension ‘stiffer’. The regulating can include decreasing the resistance torque 1521 in order to make the suspension ‘softer’. Resistance torque 1521 can be regulated using electricity delivered from a power source. In some embodiments, the electric regulation of resistance torque is performed by, or in conjunction with, an electronic module. In some embodiments, the regulation of resistance torque is performed using a control gear i.e., gearing arrangement (not shown), to change a mechanical parameter of the motor 130. Regulation of the resistance torque can be based on inputs received by a suspension-system controller 240 from one or more sensors 250, which are illustrated schematically in FIG. 2B. In the example of FIGS. 2A-B, a rotation sensor 2501 is disposed to monitor one or more rotational parameters of the rotational movement of the intermediate shaft 126, such as, for example, and not exhaustively: speed, direction, change in speed (acceleration/deceleration), and frequency of direction change. Additionally or alternatively, a rotation sensor 2502 or 2503 can be installed to monitor, for example, one or more rotational parameters of any one or more of the lead screw 118, and/or of the gear, belt, drive or bearing components of the transmission arrangement 120. In some embodiments, additional inputs to the suspension-system controller 240 for regulating the torque of the lead screw, i.e., the linear motion of the piston relative to the cylinder, are received from sensors external to the suspension system 200, such as sensors which monitor, and not exhaustively: vehicle speed, acceleration, lateral forces, roll angle, road conditions and weather.

Additionally or alternatively, some or all of the suspension control functions performed by the suspension-system controller 240 can be performed by another controller in the wheel assembly, vehicle corner module, or the vehicle that is configured, e.g., programmed, to perform the suspension control function.

The block diagram of FIG. 3 shows a set of relationships associated with a suspension-system motor, e.g., motor 130 of FIG. 2B, according to an embodiment. The motor is electrically coupled with an inverter for storage and recovery of electrical energy from a 48V battery, e.g., a main vehicle battery. A 12V battery supplies low-voltage electricity to a control circuit, e.g., the suspension-assembly 240 controller of FIG. 2A, and the control circuit is operable to control resistance torque produced by the motor.

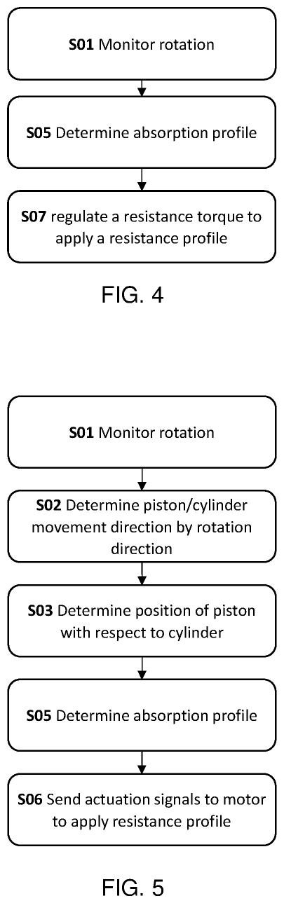

Referring now to FIG. 4, a first method is disclosed for regulating a damping force, i.e., restraining force, in a vehicle suspension assembly, e.g., any of the suspension assemblies 100 of FIGS. 1A, 1B, 2A, or 2B. The method is particularly suitable for carrying out with a suspension assembly comprising (i) a shock absorber (e.g. pneumatic shock absorber) 110, (ii) a motor, e.g., an electric motor 130, displaced externally from the shock absorber 110, and (iii) an external transmission arrangement 120 mediating between the shock absorber 110 and the motor 130. As illustrated by the flow chart in FIG. 4, the first method comprises method steps S01, S05, and S07:
Step S01 monitor rotation, e.g., detect rotation, of a rotating suspension-assembly component such as, for example, a lead screw 118 disposed within the shock absorber 110 to translate between linear motion and rotational motion, of a lead-screw shaft 122, an intermediate shaft 126, a lead-screw gear 124, an intermediate-shaft gear 128, or any other gear or bearing having bidirectional rotation;
Step S05 determining an absorption profile of the shock absorber 110, which can include performing, by a control system, e.g., suspension-system controller 240, and in response to results of the monitoring of Step S01, a look-up operation and/or a calculation; and
Step S07 responsively to an actuation signal received from the control system, e.g., suspension-system controller 240, regulating a resistance torque in the motor 130 to apply a resistance profile. The resistance profile can be a desired or pre-programmed target absorption profile for the shock absorber 110. The regulating of the damping force can be effective to regulate a linear motion 1501 of a piston portion 114 of the shock absorber 110 relative to a cylinder portion 112.

According to the method of FIG. 4, the transmission arrangement 120 is arranged to transfer the regulated resistance torque to the shock absorber 110 to regulate the damping force therein. Respective longitudinal central axes of the lead screw 118 and of a rotor portion of the motor 130 (e.g., the motor shaft 132) are aligned in parallel with each other and laterally displaced from each other. The lead screw shaft 122, intermediate shaft 126, and motor shaft 132 are aligned in parallel with each other and laterally displaced from each other.

Referring now to FIG. 5, a second method is disclosed for regulating a damping force, i.e., restraining force, in a vehicle suspension assembly, e.g., any of the suspension assemblies 100 of FIGS. 1A, 1B, 2A, or 2B. The method is particularly suitable for carrying out with a suspension assembly comprising (i) a shock absorber 110, (ii) a motor, e.g., an electric motor 130, displaced externally from the shock absorber 110, and (iii) an external transmission arrangement 120 mediating between the shock absorber 110 and the motor 130. As illustrated by the flow chart in FIG. 5, the second method comprises method steps S01, S02, S03, S05, and S06:
Step S01 (the same as Step S01 of FIG. 4) monitor rotation, e.g., observe and/or detect rotation 1502, 1503 and/or 1504, of a rotating suspension-assembly component such as, for example, a lead screw 118 disposed within the shock absorber 110 to translate between linear motion and rotational motion, a lead-screw shaft 122, an intermediate shaft 126, a lead-screw gear 124, an intermediate-shaft gear 128, or any other gear or bearing having bidirectional rotation;
Step S02 determine the direction of the linear motion 1501 of the piston 114 of the shock absorber 110 relative to the cylinder 112, by translating the monitored, e.g., observed and/or detected, rotational motion 1502, 1503 and/or 1504 of Step S01 to a direction of the linear motion.
Step S03 determine the position of the piston 114 relative to the cylinder 112, for example by carrying out a look-up operation, by a control system, e.g., suspension-system controller 240, in a position table.
Step S05 (the same as Step S05 of FIG. 4) determining an absorption profile of the shock absorber 110, which can include performing, by the control system, e.g., suspension-system controller 240, and in response to results of the monitoring of Step S01, a look-up operation and/or a calculation; and
Step S06 send actuation signals, by the control system 240 to the motor 130, to apply a resistance profile for the lead screw 118. The resistance profile can be a target profile for resistance torque (in the motor 130) corresponding to a desired or pre-programmed target absorption profile for the shock absorber 110. The resistance profile sets, e.g., regulates, the damping force regulate a linear motion 1501 of the piston relative to the cylinder 112.

According to the method of FIG. 5, the transmission arrangement 120 is arranged to transfer the regulated resistance torque to the shock absorber 110 to regulate the damping force therein. In embodiments of the method, respective longitudinal central axes of the lead screw 118 and of a rotor portion of the motor 130 (e.g., the motor shaft 132) can be aligned in parallel with each other and laterally displaced from each other. The lead screw shaft 122, intermediate shaft 126, and motor shaft 132 are aligned in parallel with each other and laterally displaced from each other.

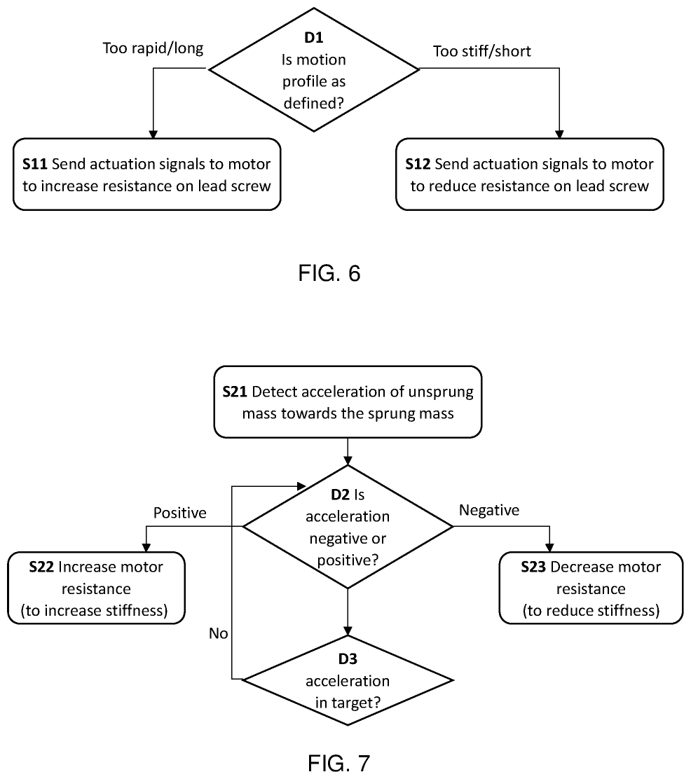

Referring now to FIG. 6, method steps are disclosed for determining which actuation signals to send, e.g., the actuation signals of method steps S06 or S07. A determination D1 is performed by the control system 240 or another control system located in the wheel assembly, corner module, vehicle platform, etc as discussed elsewhere herein. Determination D1 is for determining if the motion profile (e.g., rotational motion 1502, 1503 and/or 1504 and/or linear motion 1501) is as defined, e.g., in a target profile? If the current motion profile is determined to be too rapid or too long, then method Step S11 (a sub-step of either of method steps S06 or S07) is carried out: Send actuation signals to the motor 130 to increase resistance in the rotational motion 1502 of the lead screw 118. If the current motion profile is determined to be too stiff or too short, then method Step S12 (a sub-step of either of method steps S06 or S07) is carried out: Send actuation signals to the motor 130 to maintain or reduce resistance in the rotational motion 1502 of the lead screw 118.

Referring now to FIG. 7, method steps are disclosed for determining a change in resistance torque in the motor 130. The method steps can be performed as part of Step S06 or Step S07. First, Step S21 is carried out: Detect acceleration of unsprung mass towards the sprung mass. This can be detected, in a non-limiting example, by measuring and/or calculating an acceleration of a piston portion 114 of the shock absorber 110 relative to the cylinder portion 112. Contingent upon a detection in Step S21, a determination D2 is performed by the control system 240: Is acceleration negative or positive? If negative, then Step S23 is carried out: Decrease or maintain motor resistance to reduce or maintain stiffness. If positive, then Step S22 is carried out: Increase motor resistance to increase stiffness. The acceleration can be monitored such that at any time that acceleration is not on target profile, e.g. has not stopped or is not within a predefined range (per determination D3) the method steps cycle back through D2.

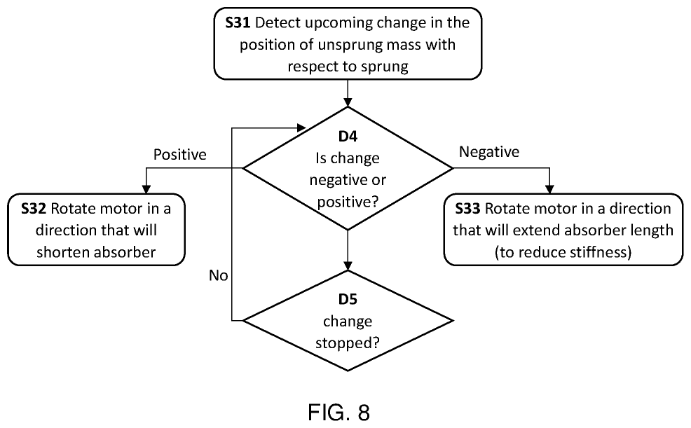

Referring now to FIG. 8, method steps are disclosed for determining an upcoming change in the position of unsprung mass, i.e., relative to the sprung mass. This can be determined, in a non-limiting example, by determining an upcoming change in the position of a piston portion 114 of the shock absorber 110 relative to that of the cylinder portion 112. The method steps can be performed as part of Step S06 or Step S07. First, Step S31 is carried out: Detect an upcoming change in the position of unsprung mass with respect to sprung. This can be detected, in a non-limiting example, based on inputs from external sensors. Contingent upon a detection in Step S31, a determination D4 is performed by the control system 240 or another control system located in the wheel assembly, corner module, vehicle platform, etc as discussed elsewhere herein: Is change negative or positive? If negative, then Step S33 is carried out: Rotate the motor 130, e.g., reduce resistance torque in the motor 130, to extend absorber length (to reduce stiffness). If positive, then Step S32 is carried out:

Rotate the motor 130, e.g., reduce resistance torque in the motor 130, to shorten absorber length. The change can be monitored such that at any time that acceleration has not stopped (per determination D5) the method steps cycle back through D4.

Any of the method steps disclosed hereinabove can be combined in any combination. Not all listed method steps are necessarily carried out in the performance of any method.

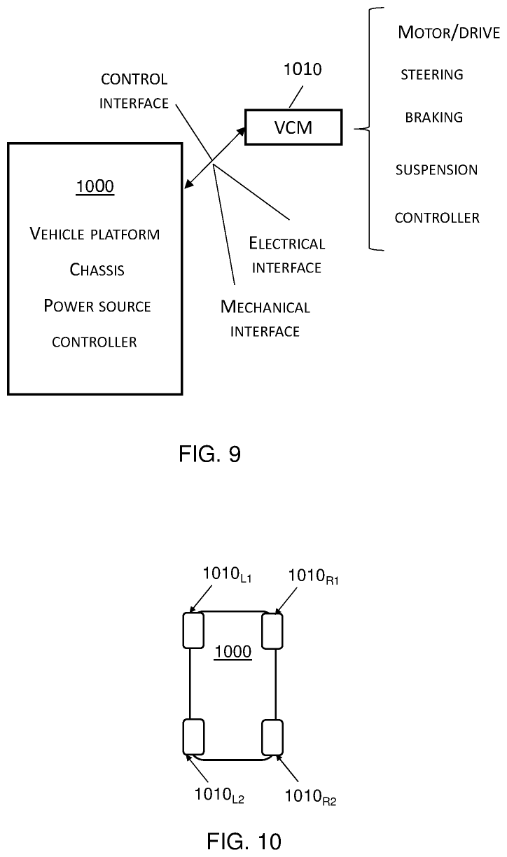

The suspension assembles disclosed elsewhere herein (e.g. 100 and 200) can be assembled in wheel assemblies and vehicle corner modules (VCMs). We now refer to FIGS. 9-12, wherein certain features of vehicle corner modules (VCMs) 1010 and of vehicles 1000 that deploy them are illustrated.

FIG. 9 shows a basic communication scheme between a VCM 1010 and a vehicle platform 1000, which enables exchanging power and signals associated with the operation of the VCM motor, steering, braking, suspension and VCM computing/controller unit. Signals may comprise control signals and data signals.

FIG. 10 shows an example of a wheeled vehicle 1000 according to embodiments. While a four-wheeled vehicle is illustrated, the embodiments of the invention can be practiced in vehicles having a smaller or larger number of wheels. FIG. 10 shows a vehicle 1000 having four VCMs 1010 installed, i.e., one at each corner, and each VCM 1010 includes a respective onboard (i.e., VCM-onboard) VCM-controller 1050 (not shown). As shown in the example of FIG. 10, a vehicle 1000 can include multiple pairs of opposing VCMs 1010, i.e., opposing wheels. In other examples (not shown) the vehicle 1000 can include just a single pair of opposing VCMs 1010 while other wheels of the vehicle 1000, if any, are implemented in other manners, e.g., using conventional arrangements for steering, drive, braking and/or suspensions systems.

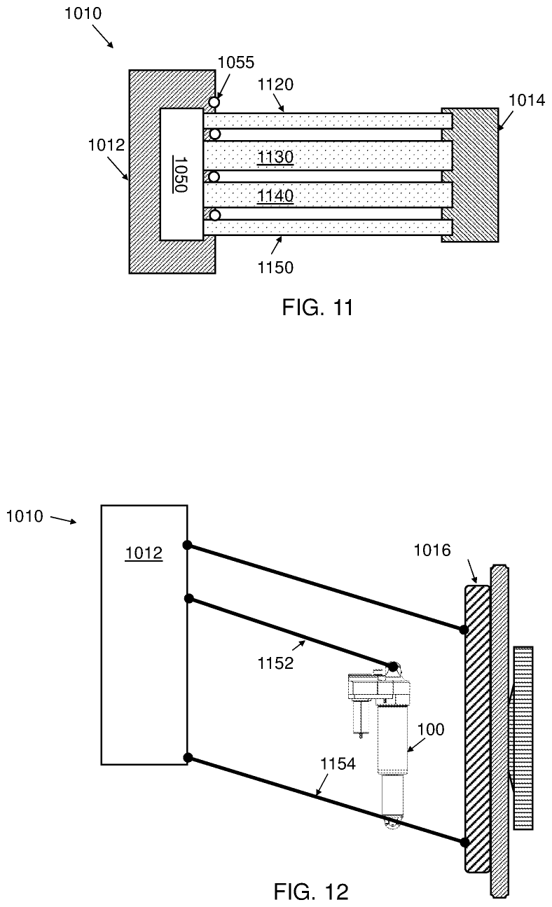

We now refer to FIG. 11. A VCM 1010 according to embodiments includes a plurality of sub-systems each comprising mechanical and/or electrical components.

Each of the sub-systems is in contact with, or connected to, a sub-frame 1012 and with a wheel interface 1014. The plurality of sub-systems of each VCM 1010 are selected from amongst the following four sub-systems:
a. Steering sub-system 1120, which can include any or all of the mechanical and/or electrical components required for steering, i.e., pivoting the wheel of the vehicle around a steering axis, including, and not exhaustively: a steering motor, a steering actuator, steering rods, steering system controller or control unit, steering inverter and wheel-angle sensor.
b. Drive system 1130, which can include any or all of the mechanical and/or electrical components required for actuating a drive shaft to rotate the wheel of the vehicle to drive the vehicle, including, and not exhaustively: an electric drive motor, a driveshaft turned by the motor, and gearing assemblies to transmit the rotation to the wheel including, optionally, a single-hear or multi-gear transmission, as well as sensors such as a wheel speed sensor (in a non-limiting example, a rotary encoder). In some embodiments, the drive motor is included in the VCM, and in some embodiments, the drive motor is on the vehicle, e.g., installed on the chassis.
c. Braking system 1140, which can include any or all of the mechanical and electrical components for actuating a brake assembly (e.g., brake disk, brake caliper, etc.) including, optionally, one or more of a VCM-onboard hydraulic system, a VCM-onboard vacuum-boost system, or a hybrid brake-assist system incorporating a pressurized-gas accumulator and brake actuator.
d. Suspension system 1150, which can optionally include an active suspension system 100/200, e.g., as discussed hereinabove with respect to FIGS. 1A, 1B, 2A, and 2B. In some embodiments, the suspension control function attributed to the suspension-system controller 240 is performed by a controller on the vehicle platform 1002 and/or by a VCM-controller 1050 and/or by a suspension controller in a different VCM.

Reference is now made to FIG. 12. For purposes of illustration, installation of the suspension assembly 100/200 includes connecting the upper component 246_{UPPER} to a suspension element 1152 connected to the sub-frame 1012 of the VCM 1010, which mounts to a vehicle 1000 or vehicle platform 1002. The exemplary installation would additionally be connected at the lower component 246_{LOWER} to a suspension arm 1154 that is linked to a wheel hub interface 1016.

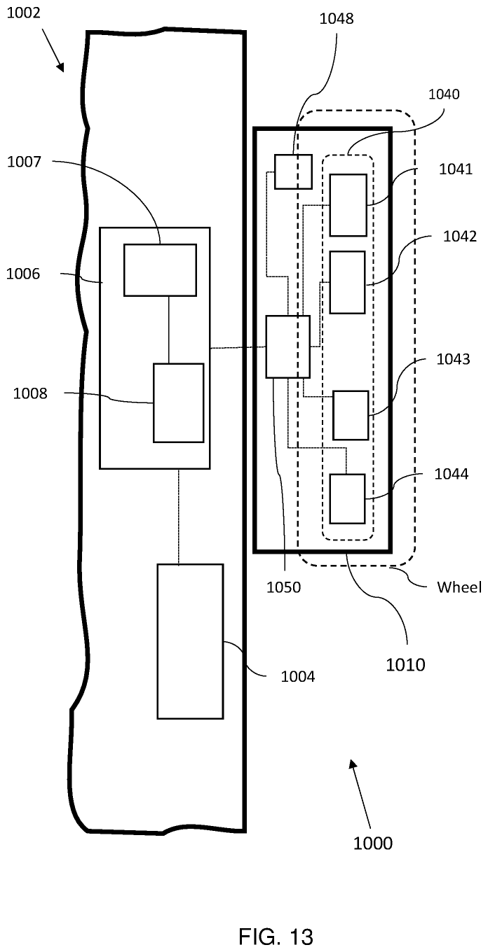

FIG. 13 depicts a schematic electrical diagram of connections between units on a vehicle platform 1002 (i.e., not onboard a VCM) and a VCM 1010. A power source 1004 may be located on the vehicle platform 1002, adapted to provide power to consumers on the platform 1002 and/or in the VCM 1010. In some embodiments, the power source 1004 includes a 48V battery. In some embodiments, the power source 1004 includes a 12V battery or a battery of some other voltage. In the example of FIG. 12, a VCM control unit (CSCU) 1006 is located on the platform 1002 and comprises a VCMs data processor 1007 and a VCMs system controller 1008. The VCM 1010 of FIG. 12 comprises one or more control units from the group 1040, and, not exhaustively: a suspension control unit (SCU) 1041, which may correspond to 240 in other embodiments, a braking control unit (BCU) 1042, a transmission control unit (TCU) 1043 and a steering control unit (STU) 1044. The VCM 1010 further comprises a VCM controller 1050 that is adapted to communicate with all other VCM sub-system control units and with VCM sensors 1048. VCM controller 1050 may be in active communication with VCM systems control unit 1008. This scheme enables flow of control and data between the vehicle platform 1002 and a VCM 1010.

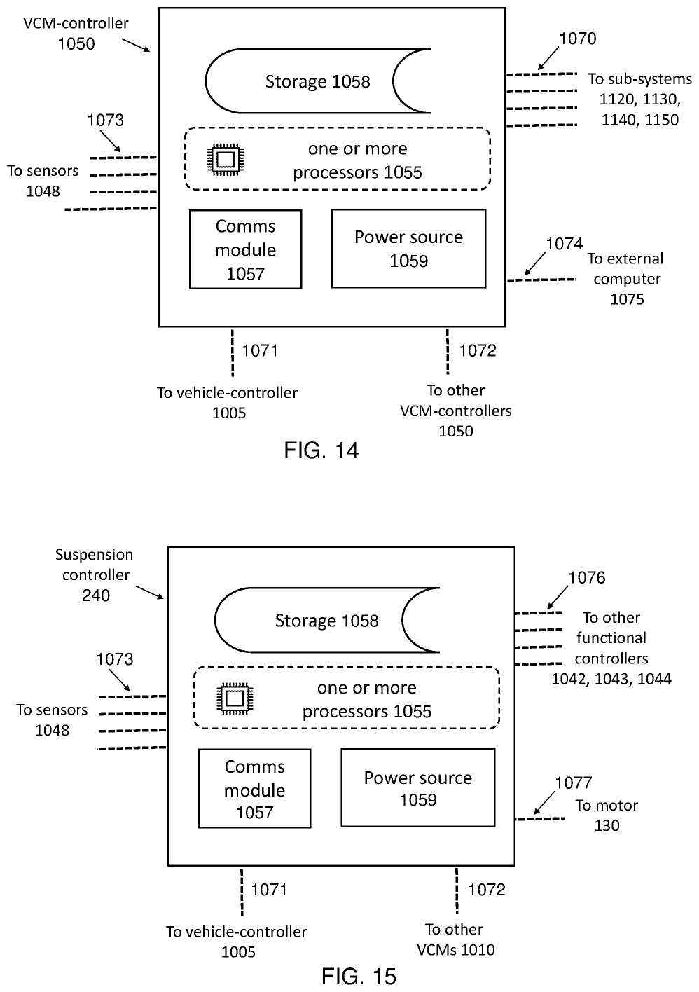

Referring now to FIG. 14, a VCM-controller 1050 according to embodiments is illustrated schematically to show selected components. The exemplary VCM-controller 1050 of FIG. 9 includes one or more computer processors 1055, a computer-readable storage medium 1058, a communications module 1057, and a power source 1059. The computer-readable storage medium 1058 can include transient and/or transient storage, and can include one or more storage units, all in accordance with desired functionality and design choices. In embodiments, the storage 1058 can be used for any one or more of: storing program instructions, in firmware and/or software, for execution by the one or more processors 1055 of the VCM-controller 1050; and historical operating data and/or maintenance data relating to the VCM and/or any one or more of its sub-systems and their components. The communications module 1057 can be configured to establish communications links with a vehicle-onboard vehicle controller 1005 via communications arrangements 1071, to other VCM controllers 1050, e.g., VCM controllers 1050 of VCMs 1010 of the same vehicle 1000, via communications arrangements 1072, to an external computer 1075 via communications arrangements 1074 to VCM subsystems 200, 180, 176, 240, including to respective sub-system control units via communications arrangements 1070, and to sensors 250 e.g., sensors 250 located in/on the VCM 1010, via communications arrangements 1073. In embodiments, not every VCM-controller 1050 includes all of the components shown in FIG. 14.

Referring now to FIG. 15, a suspension-system controller 240 according to embodiments is illustrated schematically to show selected components. The exemplary suspension-system controller 240 of FIG. 109 includes one or more computer processors 1055, a computer-readable storage medium 1058, a communications module 1057, and a power source 1059. The computer-readable storage medium 1058 can include transient and/or transient storage, and can include one or more storage units, all in accordance with desired functionality and design choices. In embodiments, the storage 1058 can be used for any one or more of: storing program instructions, in firmware and/or software, for execution by the one or more processors 1055 of the suspension-system controller 1041; and historical operating data and/or maintenance data relating to the suspension system 1150 and/or any one or more of its sub-systems and components. The communications module 1059 can be configured to establish communications links with a vehicle-onboard vehicle controller 1005 via communications arrangements 1071, to other VCM controllers 1050 e.g., VCM controllers 1050 of VCMs 1010 of the same vehicle 1000, via communications arrangements 1072, to the suspension-system motor 130 via communications arrangements 1077, to VCM sub-system control units 1042, 1043, 1044 via communications arrangements 1076, and to sensors 250 e.g., sensors 250 located in/on the VCM 1010, via communications arrangements 1073. In embodiments, not every suspension-system controller 1041 includes all of the components shown in FIG. 15.

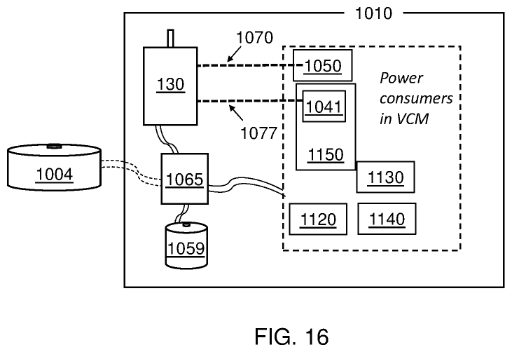

We now refer to FIG. 16, which shows a schematic representation of certain communications and electric power infrastructure elements according to embodiments. FIG. 16 shows multiple design options, not all of which are necessarily present in all embodiments, and not all possible design options are shown. In some embodiments, the suspension-system motor 130 is in electronic communication with a suspension-system controller 1041 via a communications link 1077. Either one (or both) of the two controllers 1050, 1041 can control, i.e., regulate or modulate, the operation of the suspension-system motor 130 and the specific arrangement or distribution of the control function amongst different controllers is not material. In some embodiments, the suspension-system controller 1041 is a standalone controller optionally disposed in, on or around the suspension system 1150, and in other embodiments is a module within the VCM controller 1050. In still other embodiments, there is no distinct suspension-system controller 1041 and all control functions are carried out by the VCM controller 1050. Energy generated by the suspension-system motor 130 can pass through a power electronics module 1065 which according to various embodiments can include an inverter, a transformer, a capacitor, and/or any other necessary components. The electronics module 1065 can be specific to the suspension system 1150, or shared amongst various sub-systems of the VCM 1010, or installed on the vehicle platform 1002. The energy recuperated by the suspension-system motor 130 can be stored in a local power source 1059 such as a battery or capacitor, onboard the VCM 1010, or more specifically associated with the suspension system 1150. Alternatively or additionally, the energy recuperated by the suspension-system motor 130 can be stored in a power source 1004 on the vehicle platform 1002.

In the case of a power source mounted within the VCM 1010, the recuperated energy can be used to power some or all of the components of the VCM 1010, singly or in combination with a main battery 1004 on the vehicle platform 1002.

In embodiments, an alternative or additional electronics module (not shown) can be provided between the VCM-onboard power source 1059 (and/or the on-vehicle power source 1004) and any or all of the power consumers onboard the VCM 1010. In some embodiments, a power source 1059 provided for receiving (and storing, discharging, etc.) the energy recuperated by the suspension assembly of the embodiments disclosed herein, is also configured and tasked to provide power to electronic and/or mechanical components of some or all of the sub-systems of the VCM 1010, including for example, the suspension system 1150, steering sub-system 1120, the drive system 1130, and/or the braking system 1140. In some embodiments, said power source 1059 is configured and tasked to be the primary source of power for the electronic and/or mechanical components of some or all of the sub-systems 1150, 1120, 1130, 1140. As a primary source of power it can be backed up by other local (VCM-onboard) power sources and/or a power source (such as, for example, power source 1004) onboard the vehicle platform 1002.

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

Unless otherwise indicated, a “vehicle corner module” or “VCM” as used herein means an assembly for supporting a wheel of a vehicle and regulating the motion of a vehicle according to any of the embodiments disclosed herein. The VCM assembly includes components such as (and not exhaustively): steering systems, suspension systems, braking systems including hydraulic sub-systems, gearing assemblies, drive motors, driveshafts, wheel hub assemblies, controllers, communications arrangements, and electrical wiring. In some embodiments, a VCM can include a wheel and tire. A VCM can be mounted to a ‘reference frame’ of a vehicle, e.g., a chassis or similar vehicle frame or a platform, although the mounting need not necessarily be done ‘as a unit’. When a VCM is described as being installed in/on a vehicle, then the VCM is mounted to the reference frame. A VCM may include a ‘sub-frame’ to which some or all of the VCM components are mounted or otherwise attached such that the sub-frame mediates between the reference frame and the various VCM components. The term ‘sub-frame’ should be understood to mean any rigid frame or one or more structural elements in fixed combination. The ‘sub’ prefix is intended to distinguish the sub-frame from a main frame or reference frame of the vehicle. A VCM may or may not include one or more electric motors and/or the wheel itself (and tire).

When used in this specification and in the claims appended hereto, the word “vehicle” is to be understood as referring to a motorized vehicle having one or more wheels. Non-limiting examples of a vehicle, according to this definition, are a vehicle with motive power provided by an onboard engine, and an ‘electric vehicle’ powered, when in motion, by one or more electric motors and a battery or other energy storage device onboard. The battery need not be provided with the vehicle, or installed in the vehicle, unless and until the vehicle is in motion. The word ‘vehicle’ should also be understood as encompassing a “vehicle platform” comprising at least a chassis (or other ‘reference frame’ to which VCMs can be mounted) and one or more wheels. A ‘vehicle platform’ need not necessarily comprise, at the time of providing the vehicle platform, all of the accoutrements required for transport of passengers and/or cargo such as vehicle-body components or interior furnishings.

The terms “communications arrangements” or similar terms such as “communications schemes” as used herein mean any wired connection or wireless connection via which data communications can take place. Non-limiting and non-exhaustive examples of suitable technologies for providing communications arrangements include any short-range point-to-point communication system such as

RFID Near Field Communication; wireless networks (including sensor networks) such as: Bluetooth,; and wired communications bus technologies such as CAN bus, Ethernet, Flexray, SPI, PCI, PCIe, I2C (Controller Area Network, Fieldbus, Fire Wire, HyperTransport and InfiniBand. “Establishing a communications link” as used herein means initiating and/or maintaining data communications between two or more processing units (e.g., controllers, computers, processors, etc.) in accordance with any of the communications protocols supported by the two or more communicating nodes.

As used throughout this disclosure and the claims appended hereto, the term “electrical signals” or similar terms such as “electrical inputs” means electrical and/or electronic, and includes any transmission of either direct or alternating electric current, of electronic information, or of any combination of electrical and electronic signals and information.

The term “controller” as used herein means a computing device configured for monitoring, controlling, regulating and/or actuating one or more components, systems or sub-systems. A controller should be understood to include any or all of (and not exhaustively): one or more processors, one or more computer-readable media, e.g., transient and/or non-transient storage media, communications arrangements, a power source and/or a connection to a power source, and firmware and/or software. When used herein in a hyphenated expression such as vehicle-controller or VCM-controller, the term means a controller for controlling the vehicle and/or components and/or sub-systems of the vehicle, or a controller for controlling the VCM and/or components and/or sub-systems of the VCM, respectively. Unless specifically noted otherwise, a controller is installed in or on the controlled element (vehicle, VCM, etc.) while a “control unit” is like a controller but is not installed in or on the controlled element. For example, a VCM-controller is located in or on the VCM, while a VCM control unit is not, and may be located elsewhere on the vehicle, e.g., on the chassis unit. Controllers (and control units) can be programmed in advance, e.g., by having program instructions stored in the computer-readable media for execution by one of more processors of the controller. Thus, a controller ‘configured’ to perform a function is equivalent herein to the controller being programmed, i.e., having access to stored program instructions for execution, to perform said function.

The term “shock absorber” as used herein has the usual meaning of a mechanical (and/or hydraulic and/or pneumatic) device deployed on a vehicle as part of a suspension system that can additionally include, inter alia, springs, linkages, gearing arrangements, active-suspension motors and/or controllers. The shock absorber is operative to damp, e.g., absorb or restrain, vibrations and shock impulses acting on the vehicle due mostly to variations in road or terrain surfaces. A shock absorber is effective to convert the kinetic energy of the vibration or shock into another form of energy. According to embodiments of the present invention, the kinetic energy can largely be transferred mechanically outside of the shock absorber, e.g., to other components of a vehicular suspension system, where the energy can be converted into another form of energy, such as electricity or heat. As further disclosed hereinbelow, a shock absorber comprises a cylinder portion, and a piston portion slidably engaged within an open end of the cylinder portion. One end of the shock absorber is connected to the vehicle, whether directly or indirectly via one or more elements of sprung mass, and the other end is connected with the unsprung mass of the wheel. Thus, in damping the linear motion of the piston relative to the cylinder (or, equivalently, vice versa) caused by vibrations and shocks to the wheel, the motion of the vehicle mass is regulated with respect to the motion of the wheel, for vehicle performance, for the comfort of the vehicle's occupants, and/or for their safety. The skilled artisan will understand that the decision of which one of the cylinder and the piston is connected to the vehicle, and which one is connected to the wheel, is an implementation-specific design choice, and both design options are within the scope of the present invention.

“Substantially parallel” in both cases means within ±10° of parallel, or within ±9° of parallel, or within ±8° of parallel, or within ±7° of parallel, or within ±6° of parallel, or within ±5° of parallel, or within ±4° of parallel, or within ±3° of parallel, or within ±2° of parallel, or within ±1° of parallel. The term “parallel” as used herein without a modifier can mean “substantially parallel”.

The invention has been herein described, by way of example only, with reference to the accompanying drawings. When specific reference is made to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Note: Throughout this disclosure, subscripted reference numbers (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

The invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

In the description and claims of the present disclosure, each of the verbs, “comprise”, “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise. For example, the term “a marking” or “at least one marking” may include a plurality of markings. The term “connected” or similar words such as ‘attached” or “affixed”, to the extent used herein, should be understood to include either or both of direct and indirect connection, attachment or affixing. Similarly, being “in communication”, e.g., mechanical or fluid communication, can mean being in either or both of direct and indirect communication.

1. A suspension assembly, comprising:
a. a shock absorber arranged to damp linear motion of a piston portion relative to a surrounding cylinder portion, a lead screw being disposed within the shock absorber for conversion between linear kinetic energy and rotational kinetic energy;
b. an electric motor displaced externally from the shock absorber, for conversion between rotational kinetic energy and electricity; and
c. a transmission arrangement disposed outside the shock absorber, mediating between the shock absorber and the motor, and configured to transfer a resistance torque from the motor to the lead screw so as to modulate the damping of the linear motion.

2. The suspension assembly of claim 1, wherein the transmission arrangement mediates between the lead screw and a rotor portion of the motor.

3. The suspension assembly of either one of claim 1 or 2, wherein the transmission arrangement is configured to receive a bidirectional torque from the lead screw and to transfer a unidirectional torque to a rotor portion of the motor to generate electricity.

4. The suspension assembly of any preceding claim, wherein the motor is operative to effect a change in mechanical resistance of the lead screw in response to an instruction from a control system.

5. The suspension assembly of claim 4, wherein the control system includes a rotation sensor for determining a rotation parameter of a rotating component of the transmission arrangement, and one or more computer processors for using the rotation parameter to generate the instruction.

6. The suspension assembly of claim 4, wherein the control system includes a rotation sensor for determining a rotation parameter of the lead screw, and one or more computer processors for using the rotation parameter to generate the instruction.

7. The suspension assembly of any preceding claim, wherein the lead screw is rotatably coupled to the cylinder portion, and an opposing lead-screw nut is fixedly coupled to the piston portion.

8. The suspension assembly of any preceding claim, wherein respective central axes of the lead screw and of the rotor portion of the motor are aligned with each other and laterally displaced from each other.

9. The suspension assembly of claim 8, wherein the aligning is a parallel aligning.

10. A wheel assembly comprising the suspension assembly of any preceding claim, wherein (i) either the piston portion of the shock absorber or the cylinder portion of the shock absorber is coupled to an unsprung portion of the wheel assembly, and (ii) the other of the the piston portion of the shock absorber or the cylinder portion of the shock absorber is coupled to a sprung portion of the wheel assembly.

11. The wheel assembly of claim 10, wherein the sprung portion is mechanically joined to a reference frame of a vehicle.

12. The suspension assembly of any preceding claim, wherein the shock absorber is disposed between a reference frame of a vehicle and a wheel assembly.

13. A suspension assembly comprising a shock absorber, an electric motor displaced externally therefrom, and an external transmission arrangement mediating between the shock absorber and the motor, wherein, in an operating state:
i. bidirectional linear motion of one or more shock-absorber portions is effective to bidirectionally rotate a lead screw disposed within the shock absorber and, via the transmission arrangement, unidirectionally rotate a rotor portion of the motor to generate electricity, and
ii. the transmission arrangement is effective to transfer a modulated resistance torque of the motor to the lead screw to regulate the linear motion, the resistance torque of the motor being modulated in response to an instruction from a control system.

14. The suspension assembly of claim 13, wherein the control system includes a rotation sensor for determining a rotation parameter of a rotating component of the transmission arrangement, and one or more computer processors for using the rotation parameter to generate the instruction.

15. The suspension assembly of claim 13, wherein the control system includes a rotation sensor for determining a rotation parameter of the lead screw, and one or more computer processors for using the rotation parameter to generate the instruction.

16. The suspension assembly of any one of claims 13 to 15, wherein the transmission arrangement mediates between the lead screw and the rotor portion of the motor.

17. The suspension assembly of any one of claims 13 to 16, wherein the lead screw is rotatably coupled to the cylinder portion, and an opposing lead-screw nut is fixedly coupled to the piston portion.

18. The suspension assembly of any one of claims of any one of claims 13 to 17, wherein the transmission arrangement comprises: (i) a first gear conjoined coaxially to the lead screw for bidirectional rotation together therewith, (ii) a second gear conjoined coaxially to an intermediate shaft and in geared communication with the first gear for bidirectional rotation in respective opposing directions thereto, and (iii) respective first and second unidirectional rotation-modulators engaging the first and second gears with the rotor portion so as to transfer thereto a unidirectional torque.

19. The suspension assembly of any one of claims 13 to 18, wherein respective central axes of the lead screw and of the rotor portion of the electric motor are aligned in parallel with each other and laterally displaced from each other.

20. A wheel assembly comprising the suspension of any one of claims 13 to 19, wherein (i) either the piston portion of the shock absorber or the cylinder portion of the shock absorber is coupled to an unsprung portion of the wheel assembly, and (ii) the transmission arrangement is coupled to a sprung portion of the wheel assembly.

21. The wheel assembly of claim 20, wherein the sprung portion is mechanically joined to a reference frame of a vehicle.

22. The wheel assembly of either one of claim 20 or 21, additionally comprising an energy storage device for storing electricity generated by the motor.

23. The suspension assembly of any one of claims 13 to 19, wherein the shock absorber is disposed between a reference frame of a vehicle and a wheel assembly.

24. An energy-regenerative suspension assembly, comprising:
a. a pneumatic shock absorber arranged to restrain linear motion of a piston portion relative to a surrounding cylinder portion, a lead screw being disposed within the shock absorber to translate a linear-kinetic-energy portion of the linear motion to rotational kinetic energy;
b. an electric motor displaced externally from the shock absorber, the motor being operative to convert rotational kinetic energy of a rotor portion thereof to electricity; and
c. a transmission arrangement disposed outside the shock absorber, mediating between the shock absorber and the motor, and configured to receive a bidirectional torque from the lead screw and to transfer a unidirectional torque to the rotor portion to generate electricity.

25. The suspension assembly of claim 24 wherein the transmission arrangement mediates between the lead screw and the rotor portion of the motor.

26. The suspension assembly of either one of claim 24 or 25, wherein the transmission arrangement is configured to transfer a resistance torque from the motor to the lead screw so as to modulate the restraining of the linear motion.

27. The suspension assembly of any one of claims 24 to 26, wherein the motor is operative to effect a change in mechanical resistance of the lead screw in response to an instruction from a control system.

28. The suspension assembly of claim 27, wherein the control system includes a rotation sensor for determining a rotation parameter of a rotating component of the transmission arrangement, and one or more computer processors for using the rotation parameter to generate the instruction.

29. The suspension assembly of claim 27, wherein the control system includes a rotation sensor for determining a rotation parameter of the lead screw, and one or more computer processors for using the rotation parameter to generate the instruction. The suspension assembly of any preceding claim, wherein the lead screw is rotatably coupled to the cylinder portion, and an opposing lead-screw nut is fixedly coupled to the piston portion.

30. The suspension assembly of any one of claims 24 to 29, wherein the transmission arrangement comprises: (i) a lead shaft conjoined to the lead screw to receive therefrom a bi-directional rotational motion, (ii) an intermediate shaft in rotational drive communication with the lead shaft for bidirectional rotation in respective opposing directions thereto, the intermediate shaft being in rotational drive communication with the rotor portion of the motor, the rotor portion comprising a motor shaft, and (iii) first and second unidirectional rotation-modulators respectively coupled with two shafts selected from the group of shafts containing the lead shaft, the motor shaft, and the intermediate shaft, so as to transfer a unidirectional torque to the motor shaft.

31. The suspension assembly of any one of claims 24 to 30, wherein the transmission arrangement comprises: (i) a first gear conjoined coaxially to the lead screw for bidirectional rotation together therewith, (ii) a second gear conjoined coaxially to an intermediate shaft and in geared communication with the first gear for bidirectional rotation in respective opposing directions thereto, and (iii) respective first and second unidirectional bearings engaging the lead screw and the intermediate shaft with the rotor portion so as to transfer thereto a unidirectional torque.

32. The suspension assembly of either one of claim 30 or 31, wherein the first and second unidirectional bearings are engaged with the rotor portion by respective belt drives.

33. The suspension assembly of any one of claims 24 to 32, wherein respective central axes of the lead screw and of the rotor portion of the electric motor are aligned in parallel with each other and laterally displaced from each other.

34. A wheel assembly comprising the suspension assembly of any one of claims 24 to 33, wherein (i) either the piston portion of the shock absorber or the cylinder portion of the shock absorber is coupled to an unsprung portion of the wheel assembly, and (ii) the transmission arrangement is coupled to a sprung portion of the wheel assembly.

35. The wheel assembly of claim 34, additionally comprising an energy storage device for storing electricity generated by the motor.

36. A vehicle comprising the wheel assembly of either one of claim 34 or 35, wherein the sprung portion is mechanically joined to a reference frame of the vehicle.

37. A vehicle comprising the suspension assembly of any one of claims 24 to 33, wherein the shock absorber is disposed between a reference frame of the vehicle and a wheel assembly.

38. A wheel assembly for regulating motion of a host vehicle, the wheel assembly comprising:
a. a suspension subsystem comprising an energy-regenerative suspension assembly that includes a pneumatic shock absorber and a motor, the energy-regenerative suspension assembly being configured to convert linear motion of one or more shock-absorber portions to electricity and to regulate the linear motion by modulating a resistance torque of the motor;
b. an energy storage device for storing electricity generated by the energy-regenerative suspension assembly; and
c. an electronics array for controlling the operation of the suspension subsystem and of at least one other subsystem of the wheel assembly, the at least one other subsystem selected from the group of subsystems consisting of a drive subsystem, a steering subsystem, and a braking subsystem,
wherein the electronics array is powered by the energy storage device.

39. The wheel assembly of claim 38, wherein the shock absorber includes a lead screw disposed within the shock absorber to translate a linear-kinetic-energy portion of the linear motion to rotational kinetic energy

40. The wheel assembly of claim 39, wherein the energy-regenerative suspension assembly additionally includes a transmission arrangement disposed outside the shock absorber, mediating between the shock absorber and the motor, and configured to receive a bidirectional torque from the lead screw and to transfer a unidirectional torque to the rotor portion to generate electricity.

41. The wheel assembly of claim 40, wherein the transmission arrangement is configured to transfer a resistance torque from the motor to the lead screw to modulate the restraining of the linear motion.

42. The wheel assembly of any one of claims 38 to 41, wherein a shock-absorber portion is coupled to an unsprung portion of the wheel assembly, and the transmission arrangement is coupled to a sprung portion of the wheel assembly.

43. The wheel assembly of claim 42, wherein the sprung portion is mechanically joined to a reference frame of a vehicle.

44. The wheel assembly of any one of claims 38 to 43, wherein the electronics array includes at least one electronic device selected from the group of electronic devices containing controllers and sensors.

45. The wheel assembly of claim 39, wherein the modulating of the resistance torque of the motor is in response to an instruction from a control system that includes a rotation sensor for determining a rotation parameter of the lead screw, and one or more computer processors for using the rotation parameter to generate the instruction.

46. The wheel assembly of claim 40, wherein the modulating of the resistance torque of the motor is in response to an instruction from a control system that includes a rotation sensor for determining a rotation parameter of a rotating component of the transmission arrangement, and one or more computer processors for using the rotation parameter to generate the instruction.

47. A wheel assembly for a vehicle, the wheel assembly comprising:
a. an energy-regenerative suspension assembly comprising:
i. a pneumatic shock absorber comprising two portions slidably engaged with each other, linear motion of one or more of the portions being effective to rotate a lead screw disposed within the shock absorber, and
ii. an electric motor displaced externally from the shock absorber and in geared communication therewith, for generating electricity from the linear motion and for generating a resistance torque to the lead screw to regulate the linear motion; and
b. a control system including a rotation sensor for determining a rotation parameter of the suspension assembly, and one or more computer processors for using the rotation parameter to cause a modulation of the resistance torque.

48. The wheel assembly of claim 47, wherein the suspension assembly additionally comprises a transmission arrangement mediating between the lead screw and a rotor portion of the motor, the transmission arrangement being configured to transfer a torque from the lead screw to the rotor portion for generating the electricity, and to transfer the resistance torque from the motor to the lead screw for regulating the linear motion.

49. The wheel assembly of either one of claim 47 or 48, wherein the rotation parameter includes a rotation parameter of the lead screw.

50. The wheel assembly of claim 48, wherein the rotation parameter include a rotation parameter of a rotating component of the transmission arrangement.

51. The wheel assembly of any one of claims 47 to 50, additionally comprising an energy storage device for storing electricity generated by the motor.

52. The wheel assembly of any one of claims 47 to 51, wherein the control system additionally includes at least one sensor selected from: a sensor for sensing vehicle roll, and a sensor for sensing a lateral force acting upon the wheel assembly or a component thereof, the one or more processors being configured to use a measurement of the additionally-included at least one sensor to cause the modulation of the resistance torque.

53. A method of regulating a damping force in a vehicle suspension assembly, the suspension assembly comprising (i) a pneumatic shock absorber, (ii) an electric motor displaced externally from the shock absorber, and (iii) an external transmission arrangement mediating between the shock absorber and the motor, the method comprising:
a. monitoring rotation of a suspension-assembly component;
b. determining, from the monitored rotation, an absorption profile of the shock absorber; and
c. responsively to an actuation signal received from a control system, regulating a resistance torque in the motor to apply a resistance profile,
wherein the transmission arrangement is arranged to transfer the regulated resistance torque to the shock absorber to regulate a damping force therein.

54. The method of claim 53, wherein the regulating of the damping force is effective to regulate a linear motion of a piston portion of the shock absorber relative to a cylinder portion of the shock absorber.

55. The method of either one of claims 53 o4 54, wherein a lead screw is disposed within the shock absorber to translate between linear motion and rotational motion.

56. The method of any one of claims 53 to 55, wherein respective central axes of the lead screw and of a rotor portion of the motor are aligned in parallel with each other and laterally displaced from each other.
